(19) United States
(12) Patent Application Publication
(10) Pub. No.: US 2015/0304212 A1
(43) Pub. Date: Oct. 22, 2015

(54) METHOD AND APPARATUS FOR MATCHING FLOW TABLE, AND SWITCH

(71) Applicant: Huawei Technologies Co., Ltd., Shenzhen (CN)

(72) Inventor: Zaifu Zhou, Shenzhen (CN)

(21) Appl. No.: 14/753,494

(22) Filed: Jun. 29, 2015

Related U.S. Application Data
(63) Continuation of application No. PCT/CN2013/090465, filed on Dec. 25, 2013.

(30) Foreign Application Priority Data
Dec. 28, 2012 (CN) 201210586928.3

(51) Int. Cl. H04L 12/721; H04L 12/743; H04L 12/927

(52) U.S. Cl. CPC H04L 45/38; H04L 47/80; H04L 45/7457; H04L 45/7453

(57) ABSTRACT

A method and an apparatus for matching a flow table, and a switch are provided. An exact match entry and a wildcard entry that are in each flow entry are stored separately, the exact match entry is stored in a memory, the wildcard entry is stored in a TCAM, and an index value index is used to represent the exact match entry, so that the wildcard entry uses less TCAM resources, thereby increasing utilization of the TCAM; and a proper searching algorithm is used to separately perform matching on the exact match entry and the wildcard entry, which increases a searching speed.

### CROSS-REFERENCE TO RELATED APPLICATIONS

This application is a continuation of International Application No. PCT/CN2013/090465, filed on Dec. 25, 2013, which claims priority to Chinese Patent Application No. 201210586928.3, filed on Dec. 28, 2012, both of which are hereby incorporated by reference in their entireties.

### TECHNICAL FIELD

Embodiments of the present invention relate to communications technologies, and in particular, to a method and an apparatus for matching a flow table, and a switch.

### BACKGROUND

An OpenFlow technology is first put forward by Stanford University and aims to eliminate, based on an existing TCP/IP technical condition and according to an innovative network interconnection idea, various bottlenecks generated when a current network faces a new service. A core idea of the OpenFlow technology is to change a data packet forwarding process that is originally controlled totally by a switch or a router to independent processes completed by an OpenFlow switch (OpenFlow Switch) and a control server (controller) separately. The OpenFlow switch may locally maintain a flow table (Flow Table). If a data packet that needs to be forwarded has a corresponding entry in the flow table, quick forwarding is directly performed; and if this entry is not in the flow table, the data packet is sent to the control server, so as to determine a transmission path, and then the data packet is forwarded according to the transmission path.

In a preliminary development stage of OpenFlow, a flow table in a switch is flattened, and flow entries in the flow table are categorized into two types: an completely exact match flow entry and a wildcard match flow entry. The wildcard match flow entry includes some match fields (Match Field) that need to be exactly matched and some match fields that may be wildcarded. The completely exact match flow entry is stored in an external random access memory (Random Access Memory, RAM for short) that may have a relatively large storage capacity, and quick searching is performed by means of hash (HASH). However, because there is an uncertain match field (that is, a match field that may be wildcarded) in the wildcard match flow entry, the wildcard match flow entry is stored in a ternary content-addressable memory (Ternary Content-Addressable Memory, TCAM for short) for quick searching. Because an existing technology level is limited, the TCAM has a high price and relatively large power consumption. Due to a limitation of the TCAM, generally a control server mainly downloads an exact match flow entry during implementation. Because the exact match flow entry completely defines a data flow, the flow table occupies a large capacity, which impedes development of OpenFlow.

With the development of the OpenFlow technology, in the related art, a flow table is expanded to a multi-level flow table. By using a combination of multiple flow tables, a quantity of flow entries is greatly reduced. However, only a part of characteristic data is concerned in flow entries allocated to multiple flow tables, and the other part of characteristic data needs to be provided by means of wildcard, thereby increasing a quantity of wildcard entries, and causing large occupation of a TCAM capacity.

### SUMMARY

To overcome defects in the prior art, embodiments of the present invention provide a method and an apparatus for matching a flow table, and a switch, so as to increase utilization of a TCAM.

According to an aspect, an embodiment of the present invention provides a method for matching a flow table, where the flow table includes an exact match flow table and a wildcard match flow table, the exact match flow table is stored in a memory, and the wildcard match flow table is stored in a ternary content-addressable memory; the exact match flow table includes one or more exact match entries, each exact match entry includes multiple exact match fields, and each exact match entry is corresponding to one index value; the wildcard match flow table includes one or more wildcard entries, and each wildcard entry includes multiple wildcard fields and one index field that is used for storing the index value; an exact match entry and a wildcard entry that are associated by using the index value form a complete flow entry; and the method includes:

acquiring multiple match fields in a received packet, where the multiple match fields include multiple exact match fields and multiple wildcard fields;

matching the multiple exact match fields in the packet with the multiple exact match fields of each exact match entry in the exact match flow table, and if the matching succeeds, acquiring an index value corresponding to the exact match entry; and

matching the multiple wildcard fields in the packet with the multiple wildcard fields of each wildcard entry in the wildcard match flow table according to the index value, and obtaining a matching result.

In the method provided in the embodiment of the present invention, matching the multiple exact match fields in the packet with the multiple exact match fields of each exact match entry in the exact match flow table may be performed by using a HASH algorithm.

The method provided in the embodiment of the present invention further includes:

receiving a target flow table delivered by a control server, where the target flow table includes at least one flow entry, and each flow entry includes multiple exact match fields and multiple wildcard fields;

matching the multiple exact match fields in each flow entry with the multiple exact match fields of each exact match entry in the exact match flow table; if the matching succeeds, acquiring an index value corresponding to the exact match entry; and if the matching fails, storing the multiple exact match fields of the target flow table in an exact match entry of the exact match flow table and allocating an index value to the exact match entry; and

storing the multiple wildcard fields of the target flow table in a wildcard entry of the wildcard match flow table, and storing the index value in an index field of the wildcard entry.

The method provided in the embodiment of the present invention further includes:

setting valid time for each wildcard entry in the wildcard match flow table, and after the valid time elapses, if an index value stored in the wildcard entry is different from an index value stored in another wildcard entry, deleting both the wildcard entry and an exact match entry that is corresponding to the index value; or

if an index value stored in the wildcard entry is the same as an index value stored in another wildcard entry, deleting only the wildcard entry.

According to another aspect, an embodiment of the present invention provides an apparatus for matching a flow table, where the apparatus for matching a flow table stores a flow table, the flow table includes an exact match flow table and a wildcard match flow table, the exact match flow table is stored in a memory, and the wildcard match flow table is stored in a ternary content-addressable memory; the exact match flow table includes one or more exact match entries, each exact match entry includes multiple exact match fields, and each exact match entry is corresponding to one index value; the wildcard match flow table includes one or more wildcard entries, and each wildcard entry includes multiple wildcard fields and one index field that is used for storing the index value; an exact match entry and a wildcard entry that are associated by using the index value form a complete flow entry; and the apparatus for matching a flow table includes:

an acquiring module, configured to acquire multiple match fields in a received packet, where the multiple match fields include multiple exact match fields and multiple wildcard fields;

a first matching module, configured to: match the multiple exact match fields in the packet with the multiple exact match fields of each exact match entry in the exact match flow table, and if the matching succeeds, acquire an index value corresponding to the exact match entry; and

a second matching module, configured to: match the multiple wildcard fields in the packet with the multiple wildcard fields of each wildcard entry in the wildcard match flow table according to the index value, and obtain a matching result.

In the apparatus provided in the embodiment of the present invention, the first matching module is further configured to match the multiple exact match fields in the packet with the multiple exact match fields of each exact match entry in the exact match flow table by using a HASH algorithm.

The apparatus provided in the embodiment of the present invention further includes:

a dividing module, configure to: receive a target flow table delivered by a control server, where the target flow table includes at least one flow entry, and each flow entry includes multiple exact match fields and multiple wildcard fields; match the multiple exact match fields in each flow entry with the multiple exact match fields of each exact match entry in the exact match flow table; if the matching succeeds, acquire an index value corresponding to the exact match entry; if the matching fails, store the multiple exact match fields of the target flow table in an exact match entry of the exact match flow table and allocate an index value to the exact match entry; and store the multiple wildcard fields of the target flow table in a wildcard entry of the wildcard match flow table, and store the index value in an index field of the wildcard entry.

The apparatus provided in the embodiment of the present invention further includes:

an aging processing module, configured to: set valid time for each wildcard entry in the wildcard match flow table, and after the valid time elapses, if an index value stored in the wildcard entry is different from an index value stored in another wildcard entry, delete both the wildcard entry and an exact match entry that is corresponding to the index value; or if an index value stored in the wildcard entry is the same as an index value stored in another wildcard entry, delete only the wildcard entry.

According to a still another aspect, an embodiment of the present invention provides a switch, where the switch includes a memory and a ternary content-addressable memory; a flow table includes an exact match flow table and a wildcard match flow table, the exact match flow table is stored in the memory, and the wildcard match flow table is stored in the ternary content-addressable memory; the exact match flow table includes one or more exact match entries, each exact match entry includes multiple exact match fields, and each exact match entry is corresponding to one index value; the wildcard match flow table includes one or more wildcard entries, each wildcard entry includes multiple wildcard fields and one index field that is used for storing the index value; an exact match entry and a wildcard entry that are associated by using the index value form a complete flow entry; and

the switch further includes: a processor, configured to: acquire multiple match fields in a received packet, where the multiple match fields include multiple exact match fields and multiple wildcard fields; match the multiple exact match fields in the packet with the multiple exact match fields of each exact match entry in the exact match flow table, and if the matching succeeds, acquire an index value corresponding to the exact match entry; and match the multiple wildcard fields in the packet with the multiple wildcard fields of each wildcard entry in the wildcard match flow table according to the index value, and obtain a matching result.

In the switch provided in the embodiment of the present invention, the processor is further configured to: match the multiple exact match fields in the packet with the multiple exact match fields of each exact match entry in the exact match flow table by using a HASH algorithm.

According to the method and the apparatus for matching a flow table, and the switch that are provided in the embodiments of the present invention, an exact match entry and a wildcard entry that are in a flow entry are stored separately, the exact match entry is stored in a memory, the wildcard entry is stored in a TCAM, and an index value is used to represent the exact match entry, so that the wildcard entry uses less TCAM resources, thereby increasing utilization of the TCAM; and a proper searching algorithm is used to separately perform matching on the exact match entry and the wildcard entry, which increases a searching speed.

### BRIEF DESCRIPTION OF DRAWINGS

To describe the technical solutions in the embodiments of the present invention more clearly, the following briefly introduces the accompanying drawings required for describing the embodiments of the present invention.

FIG. 1 is a flowchart of a method for matching a flow table according to an embodiment of the present invention;

FIG. 2 is a schematic diagram in which a flow table is stored in a split manner according to an embodiment of the present invention; and

FIG. 3 is a schematic structural diagram of an apparatus for matching a flow table according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention.

An OpenFlow switch is a core part in an entire OpenFlow network and mainly manages forwarding at a data layer. After receiving a packet, the switch first searches a local flow table for a target forwarding port, and if there is no matched port, the packet is forwarded to a controller, and a control layer determines the target forwarding port. The switch includes three parts: a flow table, a secure channel, and an OpenFlow protocol. The secure channel is an interface for connecting the switch to the controller. The controller controls and manages the switch through this interface, and the controller receives a notification from the switch and sends a data packet to the switch. The switch and the controller communicate with each other through the secure channel, and all information needs to be transmitted in a format stipulated in the OpenFlow protocol. The OpenFlow protocol is used to describe a standard for information used for exchange between the controller and the switch and describe a standard for an interface between the controller and the switch. A core part of the protocol is a set of structures used for OpenFlow protocol information.

An OpenFlow flow table is divided into three parts: match fields (Match Fields), counters, and a set of instructions, where the Match Fields indicate input key words for packet matching, the counters are required for management, and the set of instructions determines how a packet is to be forwarded. A most basic forwarding behavior includes: forwarding to a port, forwarding after a packet is encapsulated and rewritten, and discarding. The Match Fields are categorized into two types: One type is an exact match field, where the switch needs to completely match this field; and the other type is a wildcard field, where the switch may partly match or totally ignore this match field.

In the prior art, when there are both a wildcard field and an exact match field in a flow entry, quick searching cannot be performed by using a HASH algorithm. In a case of a specific performance requirement, a TCAM needs to be used for storage and searching. However, because a quantity of wildcard entries is relatively large, a large TCAM capacity is occupied. Inconsideration of a feature of an OpenFlow flow entry, a solution is provided in embodiments of the present invention, which is as follows: An exact match entry and a wildcard entry that are in a flow entry are separately stored, the exact match entry is stored in a memory, the wildcard entry is stored in a TCAM, and a proper searching algorithm is used to separately perform entry matching, so as to reduce occupation of the TCAM and increase utilization of the TCAM.

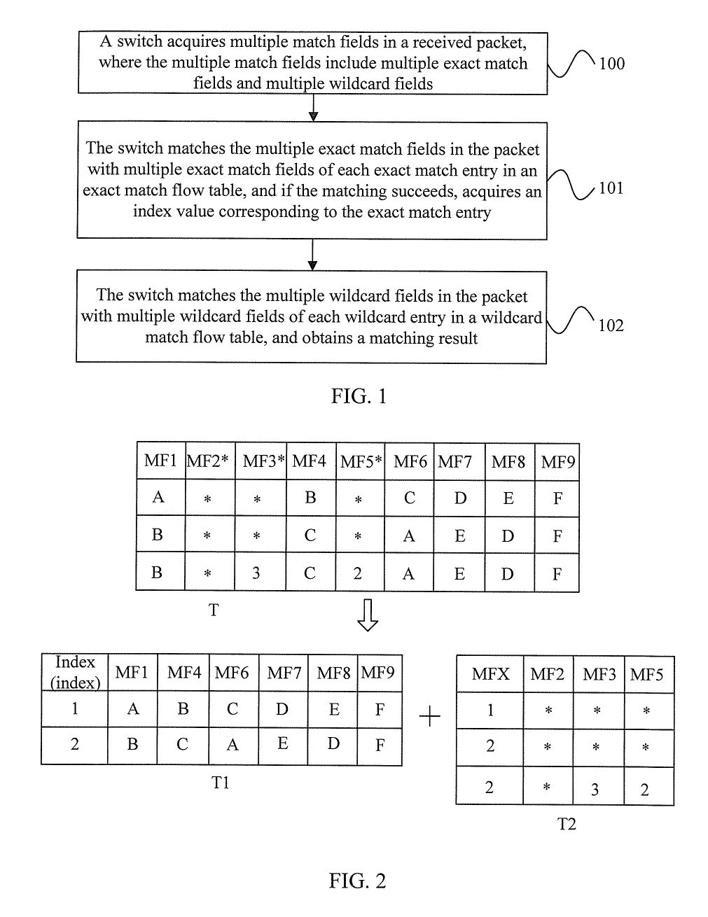

FIG. 1 is a flowchart of a method for matching a flow table according to an embodiment of the present invention. As shown in FIG. 1, the method includes:

Step 100: A switch acquires multiple match fields in a received packet, where the multiple match fields include multiple exact match fields and multiple wildcard fields.

An OpenFlow switch receives a packet that needs to be forwarded, and acquires multiple match fields from the packet, where the multiple match fields need to be matched with a locally stored flow table; the match fields include multiple exact match fields and multiple wildcard fields. For each exact match field, the switch needs to completely match each exact match field, that is, a field value of each exact match field in the packet needs to be totally the same as a field value of a corresponding exact match field in the flow table. For the wildcard field, the switch may partly match the wildcard field as long as a field value of each wildcard field in the packet is partly the same as a field value of a corresponding wildcard field in the flow table, or the switch totally ignores the wildcard field, that is, skips performing matching on the wildcard field.

FIG. 2 is a schematic diagram in which a flow table is stored in a split manner according to an embodiment of the present invention. As shown in FIG. 2, in the method provided in this embodiment of the present invention, the switch splits a maintained flow table T into two tables, including an exact match flow table T1 and a wildcard match flow table T2, where content that is not * represents an exact match field, and content that is * represents a wildcard field. The exact match flow table T1 is stored in a memory RAM (for example, SDRAM or DRAM), and the wildcard match flow table T2 is stored in a ternary content-addressable memory TCAM.

The exact match flow table T1 includes one or more exact match entries (one row in the table represents one entry), each exact match entry includes multiple exact match fields, and each exact match entry is corresponding to one index value. Correspondingly, the wildcard match flow table T2 includes one or more wildcard entries (one row in the table represents one entry), and each wildcard entry includes multiple wildcard fields and one index field that is used for storing the index value. An exact match entry and a wildcard entry that are associated by using the index value form a complete flow entry. For example, in FIG. 2, the exact match flow table T1 includes two exact match entries, and each exact match entry includes six exact match fields (MF1, MF4, MF6, MF7, MF8, MF9); and the wildcard match flow table T2 includes three wildcard entries, each wildcard entry includes three wildcard fields (MF2*, MF3*, MF5*), and each wildcard entry further includes one index field MFX. It can be seen from the figure that an exact match entry (A, B, C, D, E, F) whose index value is “1” in T1 and a wildcard entry (*, *, *) whose index value is “1” stored in the index field in T2 form a complete flow entry; an exact match entry (B, C, A, E, D, F) whose index value is “2” in T1 and a wildcard entry (*, *, *) whose index value is “2” stored in the index field MFX in T2 forma complete flow entry; and an exact match entry (B, C, A, E, D, F) whose index value is “2” in T1 and a wildcard entry (*, 3, 2) whose index value is “2” stored in the index field MFX in T2 also form a complete flow entry. In this embodiment of the present invention, an index value of an exact match entry is used as a match field of a wildcard entry, so as to achieve combination uniqueness.

Step 101: The switch matches the multiple exact match fields in the packet with the multiple exact match fields of each exact match entry in the exact match flow table, and if the matching succeeds, acquires an index value corresponding to the exact match entry.

Based on the two flow tables: the exact match flow table T1 and the wildcard match flow table T2, the switch divides a searching action in the prior art that is completed at a time into two actions to be completed.

First, matching is performed on the exact match fields. After acquiring the multiple exact match fields in the packet, the switch matches each of field values of these exact match fields with field values of the multiple exact match fields of each exact match entry in the exact match flow table T1. Because exact matching is needed, in this embodiment of the present invention, an algorithm such as HASH may be used to perform matching, and if the matching succeeds, matching continues to be performed on the wildcard fields. Before matching is performed on the wildcard fields, an index value corresponding to a successfully matched exact match entry is first acquired, and if the successfully matched exact match entry is (B, C, A, E, D, F), the index value of the exact match entry is “2”.

Step 102: The switch matches the multiple wildcard fields in the packet with the multiple wildcard fields of each wildcard entry in the wildcard match flow table according to the index value, and obtains a matching result.

After acquiring the index value “2” corresponding to the successfully matched exact match entry (B, C, A, E, D, F), the switch may continue to perform matching on the wildcard fields. Specifically, the switch uses, according to the index value “2”, the index value (index) as a match field to continue to search the wildcard match flow table T2, and then the switch learns that found wildcard entries whose values in the index field MFX in the wildcard match flow table T2 are “2” include two wildcard entries: (*, *, *) and (*, 3, 2). Then, matching the multiple wildcard fields in the packet with the multiple wildcard fields of each wildcard entry in the wildcard match flow table T2 is performed, and a matching result is obtained. If the multiple wildcard fields in the packet are (6, 4, 5), it may be learned by means of matching that the wildcard entry (*, *, *) is successfully matched, and the switch performs an operation on the packet according to an instruction corresponding to a complete flow entry (B, C, A, E, D, F, *, *, *).

If the two wildcard entries (*, *, *) and (*, 3, 2) are both successfully matched, a corresponding instruction is selected according to a priority of the flow entry to perform an operation.

In the method provided in this embodiment of the present invention, if the matching performed on the exact match field fails, the switch may send the packet to a service controller according to the prior art, so as to request a forwarding policy. The service controller formulates a forwarding policy for the packet and delivers the forwarding policy to the switch, and the switch processes the packet according to the forwarding policy.

The following introduces a process in which the service controller delivers a flow table to the switch and the switch stores the flow table in a split manner. First, the switch receives a target flow table delivered by the service controller, where the target flow table includes at least one flow entry, and each flow entry includes multiple exact match fields and multiple wildcard fields. Afterward, the switch extracts the exact match fields in the flow entry and matches the exact match fields with multiple exact match fields of each exact match entry in a current exact match flow table that is stored in a memory; if the matching succeeds, an index value corresponding to the exact match entry is acquired; if the matching fails, the multiple exact match fields of the target flow table are stored in an exact match entry of the exact match flow table, and an index value is allocated to the exact match entry. It should be noted that this index value is not a part of the exact match flow table. Then, the switch extracts the multiple wildcard fields in the target flow table, stores the multiple wildcard fields in a wildcard entry of a wildcard match flow table in a TCAM, and stores the acquired index value in a corresponding index field.

The method provided in this embodiment of the present invention may further include a flow table aging processing process in which a wildcard entry is used as a unit, where the process specifically includes: setting respective corresponding valid time for each wildcard entry in the wildcard match flow table, and when the valid time elapses, if an index value stored in the wildcard entry is different from an index value stored in another wildcard entry, deleting both the wildcard entry and an exact match entry that is corresponding to the index value. If valid time 3 s of the wildcard entry (*, *, *) whose index value is “1” stored in the index field in T2 elapses, because T2 has no another wildcard entry whose value in the index field is “01”, the wildcard entry (*, *, *) in T2 and the exact match entry (A, B, C, D, E, F) in T1 may be directly deleted.

If an index value stored in the wildcard entry is the same as an index value stored in another wildcard entry, only the wildcard entry is deleted. If valid time 5 s of the wildcard entry (*, *, *) whose index value is “2” stored in the index field in T2, because T2 has another wildcard entry whose value in the index field is also “2”, only the wildcard entry (*, *, *) in T2 is deleted, and the exact match entry (B, C, A, E, D, F) in T1 is reserved.

According to the method for matching a flow table provided in this embodiment of the present invention, an exact match entry and a wildcard entry that are in a flow entry are stored separately, the exact match entry is stored in a memory, the wildcard entry is stored in a TCAM, and an index value index is used to represent the exact match entry, so that the wildcard entry uses less TCAM resources, thereby increasing utilization of the TCAM; and a proper searching algorithm is used to separately perform matching on the exact match entry and the wildcard entry, which increases a searching speed.

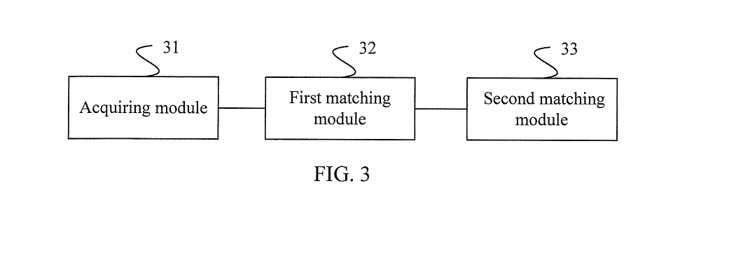

FIG. 3 is a schematic structural diagram of an apparatus for matching a flow table according to an embodiment of the present invention. As shown in FIG. 3, the apparatus for matching a flow table includes an acquiring module 31, a first matching module 32, and a second matching module 33, where the acquiring module 31 is configured to acquire multiple match fields in a received packet, where the multiple match fields include multiple exact match fields and multiple wildcard fields; the first matching module 32 is configured to: match the multiple exact match fields in the packet with multiple exact match fields of each exact match entry in an exact match flow table, and if the matching succeeds, acquire an index value corresponding to the exact match entry; and the second matching module 33 is configured to: match the multiple wildcard fields in the packet with multiple wildcard fields of each wildcard entry in a wildcard match flow table according to the index value, and obtain a matching result. The apparatus for matching a flow table stores a flow table, where the flow table includes an exact match flow table and a wildcard match flow table, the exact match flow table is stored in a memory, and the wildcard match flow table is stored in a ternary content-addressable memory; the exact match flow table includes one or more exact match entries, each exact match entry includes multiple exact match fields, and each exact match entry is corresponding to one index value; the wildcard match flow table includes one or more wildcard entries, each wildcard entry includes multiple wildcard fields and one index field that is used for storing the index value; and an exact match entry and a wildcard entry that are associated by using the index value form a complete flow entry.

Specifically, the apparatus extracts the multiple exact match fields and the multiple wildcard fields in the received packet by using the acquiring module 31, and then, the apparatus first performs, in the memory by using the first matching module 32, full match on the exact match fields, and may specifically use a HASH algorithm to perform matching. If the matching succeeds, a corresponding index value is acquired; and if the matching fails, the multiple exact match fields in the packet are stored in the exact match flow table in the memory, and an index value is allocated to the multiple exact match fields. Then, the second matching module 33 performs matching on the multiple wildcard fields in the TCAM according to the index value, and finally obtains the matching result.

According to the apparatus for matching a flow table provided in this embodiment of the present invention, an exact match entry and a wildcard entry that are in a flow entry are stored separately, the exact match entry is stored in a memory, the wildcard entry is stored in a TCAM, and an index value index is used to represent the exact match entry, so that the wildcard entry uses less TCAM resources, thereby increasing utilization of the TCAM; and a proper searching algorithm is used to separately perform matching on the exact match entry and the wildcard entry, which increases a searching speed.

The apparatus for matching a flow table provided in this embodiment of the present invention may further include a dividing module 34, configure to: receive a target flow table delivered by a control server, where the target flow table includes at least one flow entry, each flow entry includes multiple exact match fields and multiple wildcard fields; match the multiple exact match fields in each flow entry with the multiple exact match fields of each exact match entry in the exact match flow table, if the matching succeeds, acquire an index value corresponding to the exact match entry, and if the matching fails, store the multiple exact match fields of the target flow table in an exact match entry of the exact match flow table and allocate an index value to the exact match entry; and store the multiple wildcard fields of the target flow table in a wildcard entry of the wildcard match flow table, and store the index value in an index field of the wildcard entry. The apparatus divides the flow table into two parts by using the dividing module 34. However, the control server does not need to learn such division, and the control server only needs to perform processing according to the prior art, which is not affected.

The apparatus for matching a flow table provided in this embodiment of the present invention may further include an aging processing module, configured to: set valid time for each wildcard entry in the wildcard match flow table, and after the valid time elapses, if an index value stored in the wildcard entry is different from an index value stored in another wildcard entry, delete both the wildcard entry and an exact match entry that is corresponding to the index value; or if an index value stored in the wildcard entry is the same as an index value stored in another wildcard entry, delete only the wildcard entry. It can be learned that the aging processing module performs aging processing in a unit of a wildcard entry.

An embodiment of the present invention further provides a switch, including a memory, a ternary content-addressable memory, and a processor. The switch maintains a flow table, where the flow table includes an exact match flow table and a wildcard match flow table, the exact match flow table is stored in the memory, and the wildcard match flow table is stored in the ternary content-addressable memory; the exact match flow table includes one or more exact match entries, each exact match entry includes multiple exact match fields, and each exact match entry is corresponding to one index value; the wildcard match flow table includes one or more wildcard entries, and each wildcard entry includes multiple wildcard fields and one index field that is used for storing the index value; and an exact match entry and a wildcard entry that are associated by using the index value form a complete flow entry.

The processor is specifically configured to: acquire multiple match fields in a received packet, where the multiple match fields include multiple exact match fields and multiple wildcard fields; match the multiple exact match fields in the packet with the multiple exact match fields of each exact match entry in the exact match flow table, and if the matching succeeds, acquire an index value corresponding to the exact match entry; and match the multiple wildcard fields in the packet with the multiple wildcard fields of each wildcard entry in the wildcard match flow table according to the index value, and obtain a matching result. In a process in which the processor performs, in the memory, matching on the exact match fields, a HASH algorithm may be used to perform matching.

According to the switch provided in this embodiment of the present invention, an exact match entry and a wildcard entry that are in a flow entry are stored separately, the exact match entry is stored in a memory, the wildcard entry is stored in a TCAM, and an index value index is used to represent the exact match entry, so that the wildcard entry uses less TCAM resources, thereby increasing utilization of the TCAM; and a proper searching algorithm is used to separately perform matching on the exact match entry and the wildcard entry, which increases a searching speed.

In the several embodiments provided in the present invention, it should be understood that the disclosed apparatus and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The foregoing software functional unit is stored in a storage medium and includes several instructions for instructing a computer device (which may be a personal computer, a server, or a network device) or a processor (processor) to perform some of the steps of the methods described in the embodiments of the present invention. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

It may be clearly understood by persons skilled in the art that, for the purpose of convenient and brief description, division of the foregoing functional modules is used as an example for illustration. In actual application, the foregoing functions maybe allocated to different functional modules and implemented according to a requirement, that is, an inner structure of an apparatus is divided into different functional modules to implement all or some of the functions described above. For a detailed working process of the foregoing apparatus, reference may be made to a corresponding process in the foregoing method embodiments, and details are not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof; however these modifications or replacements do not make the essence of corresponding technical solutions depart from the scope of the technical solutions in the embodiments of the present invention.

What is claimed is:

1. A method for storing a flow entry in a flow table, wherein the flow entry comprises at least one exact match field and at least one wildcard match field, and the flow table comprises an exact match flow table and a wildcard match flow table, the method comprising:
extracting, by a switch, the at least one exact match field in the flow entry, and matching the at least one exact match field with exact match entries in the exact match flow table;
creating, by the switch, an exact match entry in the exact match flow table, and storing the at least one exact match field in the exact match entry of the exact match flow table, and allocating an index value to the exact match entry when the matching fails;
acquiring, by the switch, an index value corresponding to the exact match entry of the exact match flow table when the matching succeeds;
extracting, by the switch, the at least one wildcard match field in the flow entry;
creating, by the switch, a wildcard entry in the wildcard match flow table, and storing the at least one wildcard match field in the wildcard entry; and
storing, by the switch, the index value in the index field of the wildcard entry.

2. The method according to claim 1, further comprising:
setting a valid time for a first wildcard entry in the wildcard match flow table; and
when the valid time elapses, deleting both the first wildcard entry and at least one exact match entry that is corresponding to a first index value in the index field of the first wildcard entry, if the first index value stored in the first wildcard entry is different from a second index value stored in another wildcard entry.

3. The method according to claim 2, further comprising:
when the valid time elapses, deleting the first wildcard entry if the first index value stored in the first wildcard entry is the same as an index value stored in another wildcard entry.

4. A method for matching a flow table, wherein the flow table comprises an exact match flow table and a wildcard match flow table, the exact match flow table comprises one or more exact match entries, each exact match entry comprises at least one exact match field, each exact match entry corresponds to one index value, the wildcard match flow table comprises one or more wildcard entries, each wildcard entry comprises at least one wildcard field and one index field that is used for storing the index value, and an exact match entry and a wildcard entry that are associated by using the index value form a flow entry, the method comprising:
acquiring at least two match data field in a received packet, wherein the at least two match data field comprises at least one exact match data field and at least one wildcard data field;
matching the at least one exact match data field in the packet with the at least one exact match field of each exact match entry in the exact match flow table, and if the matching succeeds, acquiring an index value corresponding to the exact match entry;
matching the at least one wildcard data field in the packet with the at least one wildcard field of each wildcard entry in the wildcard match flow table according to the index value; and
obtaining a matching result.

5. The method according to claim 4, wherein matching the at least one exact match data field in the packet with the at least one exact match field of each exact match entry in the exact match flow table comprises:
matching the at least one exact match data field in the packet with the at least one exact match field of each exact match entry in the exact match flow table by using a HASH algorithm.

6. The method according to claim 4, further comprising:
setting a valid time for a first wildcard entry in the wildcard match flow table; and
when the valid time elapses, deleting both the first wildcard entry and at least one exact match entry that is corresponding to a first index value in the index field of the first wildcard entry, if the first index value stored in the first wildcard entry is different from a second index value stored in another wildcard entry.

7. The method according to claim 6, further comprising:
when the valid time elapses, deleting the first wildcard entry if the first index value stored in the first wildcard entry is the same as an index value stored in another wildcard entry.

8. A switch, comprising:
a memory and a ternary content-addressable memory;
a flow table comprising an exact match flow table and a wildcard match flow table, wherein:
the exact match flow table is stored in the memory and the wildcard match flow table is stored in the ternary content-addressable memory,
the exact match flow table comprises one or more exact match entries, wherein each exact match entry comprises at least one exact match field and corresponds to one index value,
the wildcard match flow table comprises one or more wildcard entries, and each wildcard entry comprises at least one wildcard field and one index field that is used for storing the index value, and
an exact match entry and a wildcard entry that are associated by using the index value form a flow entry; and
a processor, configured to:
acquire at least two match data field in a received packet, wherein the at least two match data field comprises at least one exact match data field and at least one wildcard data field,
match the at least one exact match data field in the packet with the at least one exact match field of each exact match entry in the exact match flow table, and if the matching succeeds, acquiring an index value corresponding to the exact match entry,
match the at least one wildcard data field in the packet with the at least one wildcard field of each wildcard entry in the wildcard match flow table according to the index value, and
obtain a matching result.

9. The switch according to claim 8, wherein the processor is further configured to:
match the at least one exact data match field in the packet with the at least one exact match field of each exact match entry in the exact match flow table by using a HASH algorithm.

10. The switch according to claim 8, wherein the processor is further configured to:
set a valid time for a first wildcard entry in the wildcard match flow table; and
when the valid time elapses, delete both the first wildcard entry and at least one exact match entry that is corresponding to a first index value in the index field of the first wildcard entry, if the first index value stored in the first wildcard entry is different from a second index value stored in another wildcard entry.

11. The switch according to claim 10, wherein the processor is further configured to:
when the valid time elapses, delete the first wildcard entry if the first index value stored in the first wildcard entry is the same as an index value stored in another wildcard entry.
